(19) United States
(12) Patent Application Publication
(10) Pub. No.: US 2025/0374180 A1
(43) Pub. Date: Dec. 4, 2025

(54) SYSTEM, METHOD AND APPARATUS TO ENABLE WAKE-UP ON TRIGGER IN A MESH NETWORK

(71) Applicant: Silicon Laboratories Inc., Austin, TX (US)

(72) Inventors: Wael Guibene, McKinney, TX (US); Jérome Emmanuel Clouté-Cazalaa, Chevreuse (FR); Sylvain Cormier, Montreal (CA); Christopher Ince, New York, NY (US)

(21) Appl. No.: 18/732,504

(22) Filed: Jun. 3, 2024

(51) Int. Cl. H04W 52/02; H04L 67/12; H04W 88/16

(52) U.S. Cl. CPC H04W 52/0203; H04L 67/12; H04W 88/16

(57) ABSTRACT

In one embodiment , a gateway includes: a host main processing unit (MPU), the host MPU having at least one core and at least one first transceiver to communicate with one or more first wireless devices in a wireless local area network (WLAN) according to a Wi-Fi protocol; and an Internet of Things (IoT) end device coupled to the host MPU via a wired interface, the IoT end device having at least one second transceiver to communicate with one or more second wireless devices in a mesh network according to at least one mesh protocol. The IoT end device is configured to cause the host MPU to exit a sleep mode in response to a trigger event from at least one of the one or more second wireless devices.

### BACKGROUND

More and more devices in homes and other locations are provided with wireless functionality. These devices range across all types of appliances, actuators, controllers, sensors, security items, and so forth. And these devices communicate in a smart home or other Internet of Things (IoT) environment. One concern in such environments is power consumption, especially as many IoT devices are small battery-operated devices. Current solutions for providing power savings are limited, adversely affecting battery life. In addition, gateways and other infrastructure in such networks are always on and consuming power, even when there is no activity in the network, undesirably increasing a user’s electricity consumption.

### SUMMARY OF THE INVENTION

In one aspect, a gateway includes: a host main processing unit (MPU), the host MPU comprising at least one core and at least one first transceiver to communicate with one or more first wireless devices in a wireless local area network (WLAN) according to a Wi-Fi protocol; and an Internet of Things (IoT) end device coupled to the host MPU via a wired interface, the IoT end device comprising at least one second transceiver to communicate with one or more second wireless devices in a mesh network according to at least one mesh protocol. The IoT end device is configured to cause the host MPU to exit a sleep mode in response to a trigger event from at least one of the one or more second wireless devices.

In an implementation, the at least one second transceiver comprises a radio coprocessor coupled to the host MPU via the wired interface. The radio coprocessor is further coupled to an IEEE 802.15.4 media access control (MAC) and physical unit (PHY), the radio coprocessor to communicate in the mesh network via the IEEE 802.15.4 MAC and PHY. The IoT end device comprises an always on domain including at least the radio coprocessor and the IEEE 802.15.4 MAC and PHY, the always on domain to remain in an active state when the host MPU is in the sleep mode.

In an implementation: the host MPU comprises a first non-volatile memory to store a first border router for the mesh network, the first border router to communicate with at least one of the one or more second wireless devices via the at least one second transceiver; and the IoT end device comprises a second non-volatile memory to store a second device for the mesh network, the second device to communicate with at least one of the one or more second wireless devices via the at least one second transceiver when the host MPU is in the sleep mode. The host MPU is to configure the mesh network using the first border router and the radio coprocessor.

In one implementation, the IoT end device is to send a wake up message to the host MPU in response to the trigger event to cause the host MPU to exit the sleep mode. In response to the wake up message, the gateway is to autonomously enter an active state and provide Internet access to the one or more first wireless devices, where when the gateway is in the sleep mode, the one or more first wireless devices do not have Internet access via the gateway. The host MPU is to configure the at least one of the one or more second wireless devices as a wake up trigger device, and in response to detection of an event and based at least in part on the configuration, the wake up trigger device is to send a notification of the trigger event to the gateway.

In another aspect, a method includes: configuring, via a first border router of a gateway, a mesh network for a plurality of IoT devices, the gateway providing Internet access for one or more wireless devices in a wireless local area network with the gateway, the gateway comprising a first IoT device; adding, via the first border router of the gateway, a second IoT device to the mesh network; and configuring a binding of the second IoT device with the first IoT device to enable the second IoT device to communicate with the first IoT device while a remainder of the gateway is in a sleep mode.

In an implementation, the method further comprises: receiving, in the first IoT device, a message from the second IoT device while the remainder of the gateway is in the sleep mode; and in response to the message, causing a host processor of the gateway to wake up. Causing the host processor to wake up comprises sending a wake up signal to the host processor via an interface that couples the first IoT device and the host processor. In response to the wake up signal, a wake up circuit of the host processor operates to cause the host processor to wake up. The method further comprises after the host processor wakes up, restoring an Internet connection for the one or more wireless devices via the gateway.

In one implementation, adding the second IoT device to the mesh network comprises communicating between the first border router of the gateway and the second IoT device via a radio coprocessor of the first IoT device. Configuring the binding of the second IoT device with the first IoT device comprises storing a wake up rule associated with the second IoT device in a rule database, the rule database accessible via a second border router of the first IoT device. The method further comprises in response to the message, accessing, via the second border router of the first IoT device, the rule database to obtain the wake up rule and based at least in part on the wake up rule, sending the wake up signal to the host processor.

In yet another aspect, an infrastructure device is to provide Internet access to one or more devices. The infrastructure device includes: an Ethernet interface to couple the infrastructure device to the Internet; a host MPU coupled to the Ethernet interface, the host MPU comprising at least one core and at least one first transceiver to communicate with one or more first wireless devices in a WLAN according to a Wi-Fi protocol, the host MPU comprising a first border router to create a mesh network; and an IoT end device coupled to the host MPU via a wired interface, the IoT end device comprising a second mesh network stack and at least one second transceiver to communicate with one or more second wireless devices in the mesh network according to at least one mesh protocol. The first border router is to add the IoT end device to the mesh network and thereafter add a trigger device of the one or more second wireless devices to the mesh network and bind the trigger device to the IoT end device. The IoT end device is configured to cause the host MPU to exit a sleep mode in response to a trigger event from trigger device.

In one implementation, the IoT end device is to maintain the mesh network active for communications by the one or more second wireless devices while the host MPU is in the sleep mode, where the WLAN is inactive while the host MPU is in the sleep mode.

In an implementation, after the host MPU exits the sleep mode, the host MPU is to restore an Internet connection via the WLAN for the one or more first wireless devices.

### BRIEF DESCRIPTION OF THE DRAWINGS

FIG. 1 is a block diagram of a wireless environment having a gateway device in accordance with an embodiment.

FIG. 2 is a flow diagram of a method in accordance with an embodiment.

FIG. 3 is a flow diagram of a method in accordance with another embodiment.

FIG. 4 is a block diagram of a representative integrated circuit in accordance with an embodiment.

FIG. 5 is a high level diagram of a network in accordance with an embodiment.

### DETAILED DESCRIPTION

In various embodiments, a gateway device and/or other infrastructure circuitry is provided with sleep and low power saving mechanisms to realize lower power consumption across a variety of devices. In this way, embodiments provide capabilities related to connectivity, power efficiency, and seamless integration in smart home and IoT environments. While embodiments can be used in connection with many different wireless protocols, implementations described herein are in the context of gateways and infrastructure having Matter functionality that can be configured to be more power agile, enabling better sleeping and power saving mechanisms.

With embodiments, several advantages are provided, including: lower power consumption with effective sleep modes and reduced need for always-on connectivity; enhanced interoperability across different network protocols, including Thread and Wi-Fi; and scalability and flexibility in deployment within diverse IoT ecosystems.

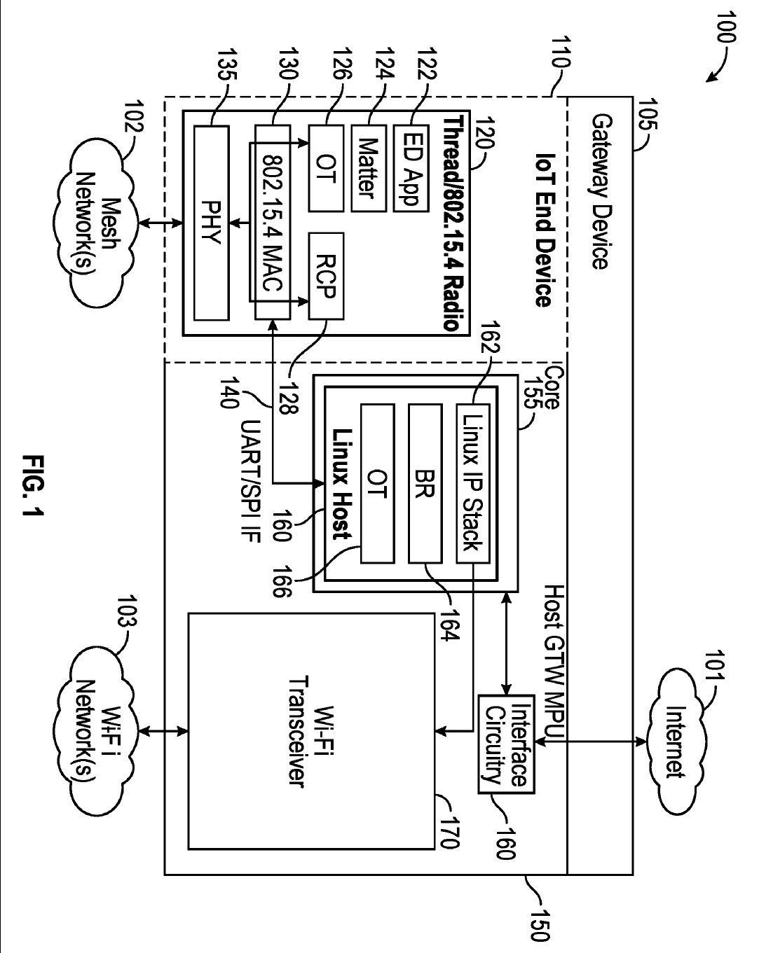

Referring now to FIG. 1, shown is a block diagram of a portion of a wireless environment having a gateway device in accordance with an embodiment. As shown in FIG. 1, wireless environment 100 may be present in a home or other building or environment. Wireless environment 100 includes a gateway device 105 that can provide an interface to the Internet 101, for one or more devices present in one or more wireless local area networks (WLANs) 103 (e.g., the Wi-Fi network shown in FIG. 1). Gateway device 105 further enables communication with one or more devices in one or more mesh networks 102 (e.g., Bluetooth Low Energy (BLE), Thread, or other such mesh networks). In one or more embodiments, gateway device 105 may be provided by an Internet service provider to its customers.

As shown gateway device 105 includes an IoT device 110, which is implemented as an Always-On subsystem, and a host gateway microprocessing unit (MPU) 150. Gateway device 105 may be implemented as a system that supports Matter devices using an OpenThread Border Router (OTBR) through a Thread-capable chip. This system allows for seamless communication between the Always-ON subsystem of IoT device 110 and host gateway MPU 150.

In embodiments, IoT device 110 may be an actual IoT device within gateway 100, such as a component of an IoT home network. As examples, IoT device 110 may be a sensor, appliance controller or so forth. In other cases, IoT device 110 may be implemented as a low power wireless system on chip (SoC), such as may be implemented in a standalone integrated circuit (IC). At a high level, such SoC may include one or more processors, memory, non-volatile storage (which may store firmware and other code) and additional components. Understand that as used herein, IoT device 110 is also referred to as a “gateway end device” or an “IoT end device,” indicating that this device is separate from host gateway MPU 150 and can be identified through a mesh network as an end node device.

In the high level view shown in FIG. 1, IoT device 110 includes a radio 120. In the embodiment shown, radio 120 may be implemented as a Thread/IEEE 802.15.4 radio. As illustrated, radio 120 includes an end device application 122, which is an application running on the end device that interacts with other devices and services in the network when host gateway MPU 150 is in a sleep mode. Application 122 is configured to maintain a Thread network and will wake-up host MPU 150 when Matter over Thread traffic is detected. Note that IoT device 110 may or may not implement full Thread border router functionalities, but in either case is it configured to receive and handle wake up control based on incoming messages from one or more devices in mesh network(s) 102.

In turn, a Matter stack 124 is configured to handle communication using the Matter protocol, ensuring interoperability between smart home devices. An OpenThread (OT) stack 126 provides the implementation of the Thread networking protocol corresponding to an OT stack present on host gateway MPU 150. A Radio Co-Processor (RCP) 128 may be implemented as a dedicated processor for handling radio communication tasks, offloading these from the main application processor.

Still referring to FIG. 1, radio 120 further includes a Media Access Control (MAC) layer 130, which may be implemented as an IEEE 802.15.4 layer to manage access to a physical radio channel, and handle tasks like addressing and channel access. A Physical Layer (PHY) 135 is configured to be responsible for the transmission and reception of radio signals to devices within mesh network 102.

Still referring to FIG. 1, gateway device 105 also includes host gateway MPU 150 (also referred to herein as a “host” or “host processor”). MPU 150 may include one or more processors such as a representative core 155 to handle various functionality, including implementation of a computing environment 160. As further shown MPU 150 also includes a wireless transceiver 170, which as shown may be implemented as a Wi-Fi transceiver (which may be part of a multi-protocol transceiver).

As shown, IoT device 110 communicates with host MPU 150 via an interface 140. In embodiments, interface 140 may be a physical interface implemented as a wired interface. In various embodiments, interface 140 may communicate according to a Universal Asynchronous Receiver/Transmitter (UART) or Serial Peripheral Interface (SPI) to provide for data communication.

Computing environment 160 may be implemented as a general-purpose computing environment that hosts various components. As shown, computing environment 160 includes a Linux IP stack 162, which may be configured as a network stack running on a Linux operating system, to handle IP-based communication. Computing environment 160 also includes a Border Router (BR) 164 to manage the traffic between different network segments, and acts as a bridge between the Thread network and other IP-based networks. Computing environment 160 also includes an OT stack 166 to provide network management and routing functions.

In turn, Wi-Fi transceiver 170 provides wireless connectivity for gateway device 105, to communicate with one or more devices present in WLAN network(s) 103. As further shown, MPU 150 couples to an interface circuit 180, which may be an Ethernet interface to couple the gateway to Internet 101 (and/or other networked devices). Although shown at this high level in the embodiment of FIG. 1, understand that many variations and alternatives are possible.

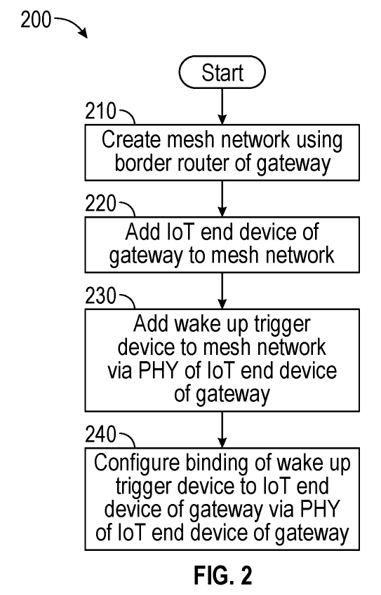

Referring now to FIG. 2, shown is a flow diagram of a method in accordance with an embodiment. More specifically, method 200 of FIG. 2 is a method for configuring a mesh network and its included devices. Method 200 may be performed on initialization of a gateway within a given mesh network, and can be performed by a user interacting with the gateway via an application. Various hardware of the gateway and additional devices within the mesh network may be used to perform method 200. As such, method 200 may be performed by hardware circuitry in combination with firmware and/or software.

As illustrated, method 200 begins by creating a mesh network (block 210). This mesh network may be created using a border router included within a gateway device. Depending upon implementation, a user can initiate the network (which in an example may be a Thread network) via an application (e.g., a Matter or Thread application) connected to the gateway device, which may be executed on a smart phone connected to the gateway device via a Wi-Fi or other WLAN. In another example, the user can create the network via a gateway application (which may execute on a client system) that is accessible using a web interface, e.g., that executes on a client computer coupled to the gateway via a wired or wireless interface. As part of network configuration, various parameters of the network can be configured, via the border router, including definition of a Thread channel and Thread credentials.

Still with reference to FIG. 2, at block 220 an end device of the gateway may be added to the mesh network. More specifically, this end device may include a low power wireless SoC that is configured with functionality such as discussed above regarding FIG. 1 (IoT device 150). As such, this end device includes a RCP, and can communicate both with the border router of the gateway (e.g., via a wired interface) and with wireless devices of the mesh network via a given one of multiple supported wireless protocols. As with the above discussion, the same user application can commission this IoT end device of the gateway. In the case of a gateway-based application, a Thread protocol may be used for this device commissioning. Note that the commissioning process may be in accordance with a given one of a Thread or Matter specification. In the case of a Matter-based commissioning, the IoT end device of the gateway may have an active Bluetooth connection to enable the commissioning. For a Thread-based commissioning, note that no packets need actually be transmitted through the IoT end device as a radio coprocessor and Thread application are present in the IoT end device itself and thus can communicate with the gateway MPU via the wired interface between the two devices of the gateway. Thus at this point a mesh network is established and the IoT end device of the gateway is commissioned such that additional mesh-based communications may be via circuitry of the IoT end device itself.

Next at block 230, a wake up trigger device can be added to the mesh network. Note that this wake up trigger device can be a device within the mesh network that may provide a wake up trigger to the gateway when a given event occurs while the gateway is in a sleep or other low power mode. While block 230 is described for a single wake up trigger device, understand that there may be many different wake up trigger devices present within a given mesh network, and these different devices can be added as additional wake up trigger devices. As with the above discussion, the same user application can commission this wake up trigger device (and in the case of a gateway-based application, a Thread protocol may be used), in accordance with a given one of a Thread or Matter specification-based process. In one implementation, the wake up trigger device can be added to the mesh network via communication with the IoT end device of the gateway via a PHY of the IoT end device. Thus this communication may occur via a given Thread or Matter protocol to add this wake up trigger device to the mesh network.

Still with reference to FIG. 2, control then passes to block 240, where a binding of the wake up trigger device to the IoT end device of the gateway can be configured. Again, this configuration process may occur via the PHY of the IoT end device of the gateway, which provides the exchanges to the RCP and IoT end device application coupled above the PHY. In an embodiment, the same user application as discussed above may provide rules for the binding. In an example such rules may include binding a door/window contact sensor, a motion detection sensor, a light switch or any end-user activity detection mechanism to the gateway IoT end device. These rules may be stored in a rule database of the IoT database. Similar binding rule information may be stored in the trigger device.

Based on this binding, an event from a wake up trigger device is directly addressed to the IoT end device of the gateway (which may take action including waking up the host gateway MPU). Thus at this point, a mesh network is established that includes a gateway having an always on IoT end device in accordance with an embodiment that enables a host processor of the gateway to be placed into a sleep mode when the mesh network has minimal or no activity. For example, this low activity situation may occur when residents of the home are away, asleep for the night, or so forth. Although shown at this high level in the embodiment of FIG. 2, many variations and alternatives are possible.

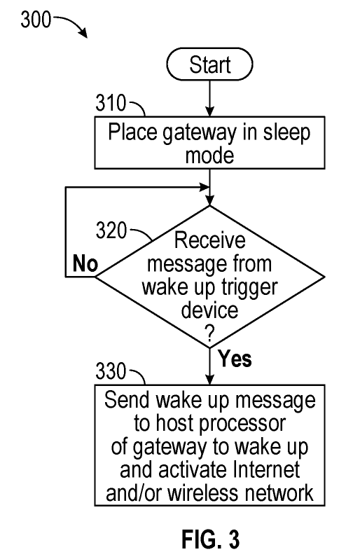

Referring now to FIG. 3, shown is a flow diagram of a method in accordance with another embodiment. More specifically, method 300 of FIG. 3 is a method for operating a gateway in a sleep mode, and exiting from the sleep mode when activity is detected within a mesh network with which it is associated. As such, method 300 may be performed by hardware circuitry within the gateway, including an IoT end device and a host processor of the gateway alone and/or in combination with firmware and/or software.

As shown, method 300 begins by placing the gateway into a sleep mode (block 310). While many triggers may cause entry into a sleep mode, assume for purposes of discussion that the gateway is placed in the sleep mode when inactivity is detected. Note that this inactivity may be with regard to Internet, Wi-Fi, and/or mesh communications. For example, the inactivity may be due to residents being away from home, asleep or for other reasons. Understand that in the sleep mode, a host gateway MPU is placed into a low power state and is inactive. As such, there is no Internet availability. Nor is a WLAN such as a Wi-Fi network available via this gateway. Further in this sleep mode, a communication path between the MPU and the IoT end device of the gateway is inactive as the OTBR of the host gateway MPU is inactive.

However, understand that even while in the sleep mode, the IoT end device of the gateway (including its Thread and/or Matter stacks) is active. Thus the mesh network including its connection to the gateway remains fully operational. In an embodiment in which the IoT end device is a Thread router, it can route mesh network packets, even while the host MPU is in the sleep mode. And as this IoT end device has much lower power consumption than the host gateway MPU, significant power conservation can be realized, while still providing the capability of exiting the sleep mode when certain activity is detected.

Thus at this point, the host gateway MPU is in a low power state while the IoT end device remains active. Next at block 320 it is determined whether a message is received from a wake up trigger device. Note that this wake up trigger device can be, for example, a door sensor. In this case, assume that the trigger is detection by the door sensor of an opening of the associated door. Based on the pre-configured binding between this wake up trigger device and the IoT end device of the gateway device, this message is sent. As an example, the message can be in the form of a wake up message that is sent based on a binding configuration that binds the given wake up trigger device with the IoT end device of the gateway. In other cases, the message can be a simple indication of some determination of activity by a given one of the IoT devices of the mesh network.

Note that this message is received while the host processor is sleeping, and thus the RCP of the IoT end device cannot access a Thread stack of the border router of the host MPU. Stated another way, packets on this path are lost as this host-included border router is inactive. However, the mesh network remains fully operational, since the IoT end device of the gateway is on, and its Thread (and possibly Matter) end device application is running.

When it is determined that a bound message is received, control passes to block 330. At block 330, the IoT end device of the gateway sends (e.g., via an end device application) a wake up message to the host processor of the gateway, e.g., via a wired interface of the gateway to cause the host processor to wake up. For example, this wake up message can be directed to a wake up means of the host processor such as by communication of an interrupt via a general purpose input/output (GPIO) pin of a power management unit of the host gateway MPU (or another similar operation).

In response to this wake up message, the host gateway MPU enters into an active state, and causes additional networks to be activated, namely connection to the Internet and/or wireless networks such as a Wi-Fi WLAN.

As a specific example of a trigger event-induced wake up, assume that the trigger event occurs from another IoT device (e.g., a Thread (and possibly Matter end device), and further assume that the IoT device is a door sensor that detects the opening of a front door as a user returns from vacation. Based on this device’s binding (as indicated by a binding configuration in the device) to the IoT end device, the device sends a message to the IoT end device. In response to this message, the end device application that executes on the IoT end device, sends a signal to cause the host MPU to wake up and re-activate the gateway connections. In this way, without any end user action other than opening a door in this use case, the gateway is powered back on (e.g., after an extended power savings duration), and gateway-controlled networks, including the Internet and a Wi-Fi network, are back active. Understand although shown at this high level in the embodiment of FIG. 3, many variations and alternatives are possible.

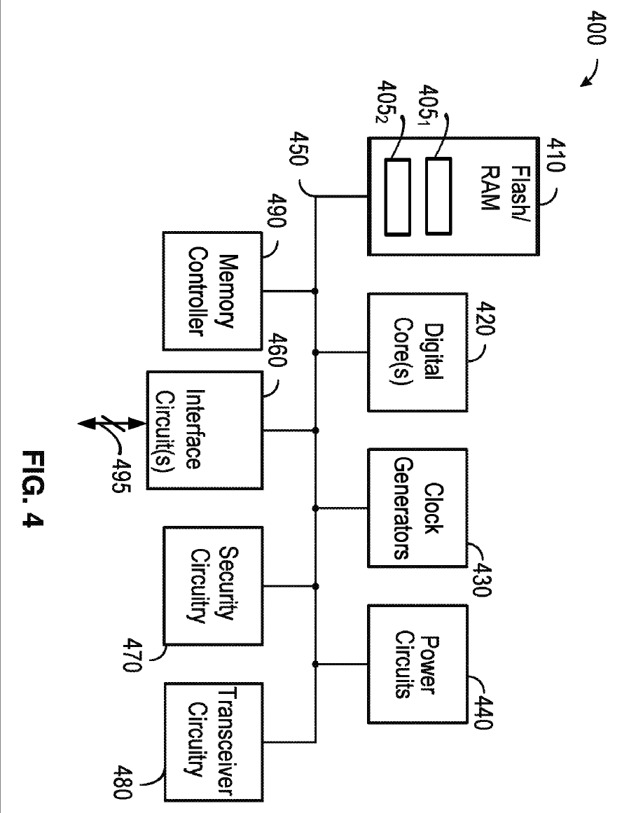

Referring now to FIG. 4, shown is a block diagram of a representative integrated circuit 400 that includes low power IEEE 802.15.4 transceiver circuitry, as described herein. In the embodiment shown in FIG. 4, integrated circuit 400 may be, e.g., a multi-mode wireless transceiver that may operate according to one or more wireless protocols (e.g., Thread and Bluetooth, among others) or other device that can be used in a variety of use cases. In one or more embodiments, the circuitry of integrated circuit 400 shown in FIG. 4 may be implemented on a single semiconductor die or implemented on separate dies for wireless communication, MCU compute, external flash and/or other IP blocks needed to perform the gateway IoT end device functionalities.

Integrated circuit 400 may be included in a range of devices, but for purposes of discussion, it may be incorporated into a gateway or other infrastructure device as described herein. In the embodiment shown, integrated circuit 400 includes a memory system 410 which in an embodiment may include volatile storage, such as RAM and non-volatile memory such as a flash memory. The flash memory is a non-transitory storage medium that can store instructions and data. In embodiments, this storage may store firmware 405₁ for a Thread and/or Matter protocol stack, a radio coprocessor and a border router, and an end device application 405₂, as described herein. As further shown integrated circuit 400 also may include a memory controller 490.

Memory system 410 couples via a bus 450 to one or more digital cores 420, which may include one or more cores and/or microcontrollers that act as processing units of the integrated circuit, and which may execute an IoT end device application to handle incoming trigger events from one more wake up trigger devices with which it is bound. In turn, digital cores 420 may couple to clock generators 430 which may provide one or more phase locked loops or other clock generator circuitry to generate various clocks for use by circuitry of the IC.

As further illustrated, IC 400 further includes power circuitry 440. Additional circuitry may be present depending on particular implementation to provide various functionality and interaction with external devices. Such circuitry may include interface circuitry 460 which provides a digital communication interface with additional circuitry (such as a host MPU of a gateway to couple to IC 400 via a link 495). IC 400 also may include security circuitry 470 to perform wireless security techniques.

In addition, as shown in FIG. 4, transceiver circuitry 480 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. Understand while shown with this high level view, many variations and alternatives are possible.

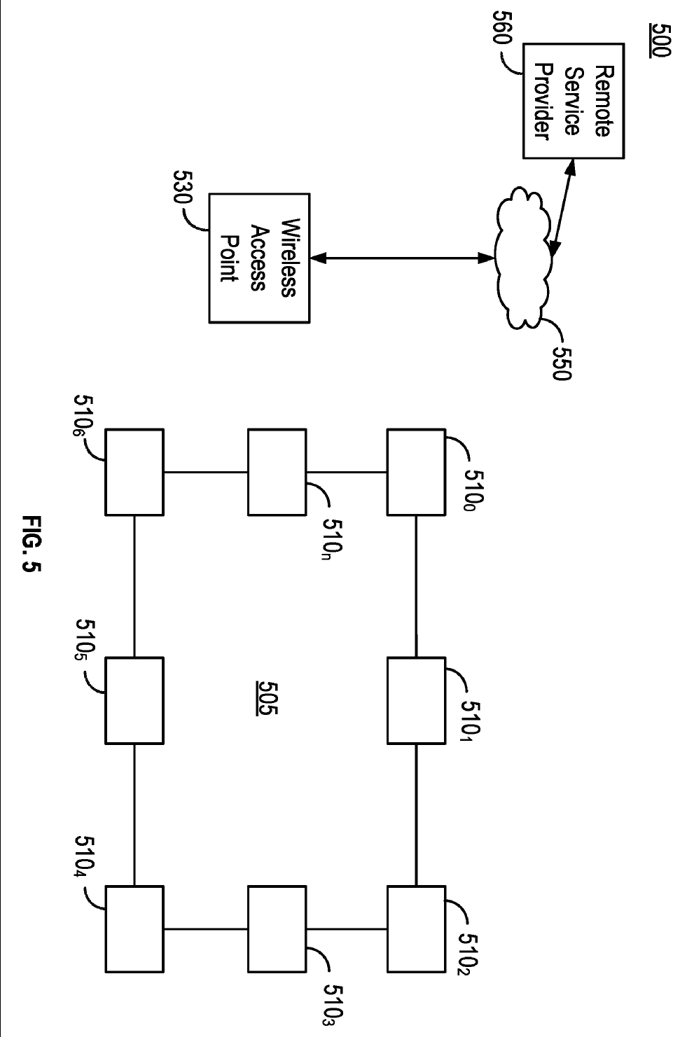

ICs such as described herein may be implemented in a variety of different devices as described above. Referring now to FIG. 5, shown is a high level diagram of a network in accordance with an embodiment. As shown in FIG. 5, a network 500 includes a variety of devices, including IoT devices, access points and remote service providers, which may leverage embodiments for enabling a low power coprocessor of a gateway or other access point to remain active while a host processor is in a sleep mode, thus reducing power consumption, potentially significantly in the case of an inactive smart network.

In the embodiment of FIG. 5, a wireless mesh network 505 is present, e.g., in a building having multiple wireless devices 510₀₋ₙ. As shown, wireless devices 510 couple to an access point 530 that in turn communicates with a remote service provider 560 via a wide area network 550, e.g., the Internet. Access point 530 may include infrastructure circuitry as discussed above in FIG. 1. Understand while shown at this high level in the embodiment of FIG. 5, many variations and alternatives are possible.

Embodiments thus provide an automated power save mode that can save significant power, not only for a single user location, but network-wide savings when implemented in ISP gateways, Wi-Fi extenders, and other infrastructure devices. In this way, sleep mode can be entered/existed without any physical user interactions, like pressing a button or touchscreen. Rather, embodiments can trigger entry/exit from sleep mode based only on presence (or non-presence) detection, to cause connected Wi-Fi or other networks to be ON or OFF.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed:

1. A gateway comprising:
a host main processing unit (MPU), the host MPU comprising at least one core and at least one first transceiver to communicate with one or more first wireless devices in a wireless local area network (WLAN) according to a Wi-Fi protocol; and
an Internet of Things (IoT) end device coupled to the host MPU via a wired interface, the IoT end device comprising at least one second transceiver to communicate with one or more second wireless devices in a mesh network according to at least one mesh protocol, wherein the IoT end device is configured to cause the host MPU to exit a sleep mode in response to a trigger event from at least one of the one or more second wireless devices.

2. The gateway of claim 1, wherein the at least one second transceiver comprises a radio coprocessor coupled to the host MPU via the wired interface.

3. The gateway of claim 2, wherein the radio coprocessor is further coupled to an IEEE 802.15.4 media access control (MAC) and physical unit (PHY), the radio coprocessor to communicate in the mesh network via the IEEE 802.15.4 MAC and PHY.

4. The gateway of claim 3, wherein the IoT end device comprises an always on domain including at least the radio coprocessor and the IEEE 802.15.4 MAC and PHY, the always on domain to remain in an active state when the host MPU is in the sleep mode.

5. The gateway of claim 1, wherein:
the host MPU comprises a first non-volatile memory to store a first border router for the mesh network, the first border router to communicate with at least one of the one or more second wireless devices via the at least one second transceiver; and
the IoT end device comprises a second non-volatile memory to store a second device for the mesh network, the second device to communicate with at least one of the one or more second wireless devices via the at least one second transceiver when the host MPU is in the sleep mode.

6. The gateway of claim 5, wherein the host MPU is to configure the mesh network using the first border router and the radio coprocessor.

7. The gateway of claim 1, wherein the IoT end device is to send a wake up message to the host MPU in response to the trigger event to cause the host MPU to exit the sleep mode.

8. The gateway of claim 7, wherein in response to the wake up message, the gateway is to autonomously enter an active state and provide Internet access to the one or more first wireless devices, wherein when the gateway is in the sleep mode, the one or more first wireless devices do not have Internet access via the gateway.

9. The gateway of claim 1, wherein the host MPU is to configure the at least one of the one or more second wireless devices as a wake up trigger device, wherein in response to detection of an event and based at least in part on the configuration, the wake up trigger device is to send a notification of the trigger event to the gateway.

10. A method comprising:
configuring, via a first border router of a gateway, a mesh network for a plurality of Internet of Things (IoT) devices, the gateway providing Internet access for one or more wireless devices in a wireless local area network with the gateway, the gateway comprising a first IoT device;
adding, via the first border router of the gateway, a second IoT device to the mesh network; and
configuring a binding of the second IoT device with the first IoT device to enable the second IoT device to communicate with the first IoT device while a remainder of the gateway is in a sleep mode.

11. The method of claim 10, further comprising:
receiving, in the first IoT device, a message from the second IoT device while the remainder of the gateway is in the sleep mode; and
in response to the message, causing a host processor of the gateway to wake up.

12. The method of claim 11, wherein causing the host processor to wake up comprises sending a wake up signal to the host processor via an interface that couples the first IoT device and the host processor.

13. The method of claim 12, wherein, in response to the wake up signal, a wake up circuit of the host processor operates to cause the host processor to wake up.

14. The method of claim 13, further comprising after the host processor wakes up, restoring an Internet connection for the one or more wireless devices via the gateway.

15. The method of claim 12, wherein adding the second IoT device to the mesh network comprises communicating between the first border router of the gateway and the second IoT device via a radio coprocessor of the first IoT device.

16. The method of claim 15, wherein configuring the binding of the second IoT device with the first IoT device comprises storing a wake up rule associated with the second IoT device in a rule database, the rule database accessible via a second border router of the first IoT device.

17. The method of claim 16, further comprising in response to the message, accessing, via the second border router of the first IoT device, the rule database to obtain the wake up rule and based at least in part on the wake up rule, sending the wake up signal to the host processor.

18. An infrastructure device to provide Internet access to one or more devices, the infrastructure device comprising:
an Ethernet interface to couple the infrastructure device to the Internet;
a host main processing unit (MPU) coupled to the Ethernet interface, the host MPU comprising at least one core and at least one first transceiver to communicate with one or more first wireless devices in a wireless local area network (WLAN) according to a Wi-Fi protocol, the host MPU comprising a first border router to create a mesh network; and
an Internet of Things (IoT) end device coupled to the host MPU via a wired interface, the IoT end device comprising a second mesh network stack and at least one second transceiver to communicate with one or more second wireless devices in the mesh network according to at least one mesh protocol, wherein the first border router is to add the IoT end device to the mesh network and thereafter add a trigger device of the one or more second wireless devices to the mesh network and bind the trigger device to the IoT end device, and the IoT end device is configured to cause the host MPU to exit a sleep mode in response to a trigger event from trigger device.

19. The infrastructure device of claim 18, wherein the IoT end device is to maintain the mesh network active for communications by the one or more second wireless devices while the host MPU is in the sleep mode, wherein the WLAN is inactive while the host MPU is in the sleep mode.

20. The infrastructure device of claim 18, wherein after the host MPU exits the sleep mode, the host MPU is to restore an Internet connection via the WLAN for the one or more first wireless devices.
